(19) United States
(12) Patent Application Publication
(10) Pub. No.: US 2006/0075762 A1
(43) Pub. Date: Apr. 13, 2006

(54) LNG regas

(76) Inventors: Wim van Wijngaarden, KH Gorinchem (NL); Matthieu Ubas, CD Rotterdam (NL)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/222,473

(22) Filed: Sep. 8, 2005

Related U.S. Application Data
(60) Provisional application No. 60/610,432, filed on Sep. 16, 2004.

(51) Int. Cl. F17C 9/02; B65B 1/28; B65B 1/20; B65B 3/18

(52) U.S. Cl. 62/50.2; 141/82

(57) ABSTRACT

Liquefied hydrocarbon gas is carried in a tanker (12) to an offshore location where the liquefied gas is to be transferred to an offloading facility (20) such as a barge (21). At the offshore location the liquefied gas is to be heated to change it into a gaseous state and to heat the cold gas to produce warmed gas of at least about 0° C., with the warmed gas transferred to a storage facility (32, 33). Heating is accomplished without using only sea water and the burning of gas, by using air blowers (36, 38, 52) that blow large amounts of environmental air past containment structures (14, 28, 32, 42, 44) such as tanks, pipes and heat exchangers thermally coupled to the tanks and pipes, in which the liquefied or cold gas lies.

### CROSS-REFERENCE

Applicant claims priority from U.S. provisional application. 60/610,432 filed Sep. 16, 2004.

### BACKGROUND OF THE INVENTION

Gaseous hydrocarbons, which are hydrocarbons that are gaseous at mild environmental temperatures such as 15° C. and atmospheric pressure, are often transported great distances by tanker in liquid form (“liquefied gas”) as LNG (liquefied natural gas) or as LPG (liquefied petroleum gas, commonly containing primarily propane and butane). To keep LNG liquid, it is maintained at a low temperature such as −160° C. in highly thermally insulated tanks. At the tanker offloading destination, the LNG or LPG is offloaded to an offloading facility where it is regassed (heated to turn it into a gas) and warmed, and where the warmed gas is passed though a pipeline to users or stored.

The heating of large quantities of liquefied gas can be done by flowing large quantities of seawater though a heat exchanger. However, such use of large quantities of seawater is not acceptable in many areas because large quantities of sea life such as fish eggs and small fish that flow into the sea water intake are destroyed, and because large decreases in local sea water temperature can harm sea life in general. Local regulations are increasing limiting the use of sea water for such liquefied gas heating, especially in harbors where the seawater is largely isolated from the ocean. An alternative is the burning of fuel such as hydrocarbon gas to create hot gases that heat the rest of the hydrocarbon gas (e.g. in submerged combustion vaporization), but this uses large amounts of valuable fuel and creates environmentally harmful nitrogen oxides and chemically treated discharge that goes into the sea.

### SUMMARY OF THE INVENTION

In accordance with the present invention, applicant heats liquid hydrocarbon gas that has been transported in a liquefied state (“liquefied gas”) by a tanker across a long distance to an offshore offloading facility lying close to the final destination of the gas, by a method and apparatus that is of low cost and that is environmentally friendly, especially where the offloading facility lies close (e.g. within several kilometers) to the shore or in a harbor. The heating of the liquefied hydrocarbon gas is accomplished by the use of large fans or blowers that blow environmental air past a containment structure such as a tank or pipe and associated heat exchange devices. The blowers may be located on the offloading facility, and may blow environmental air past containment structures such as tanks and pipes on the tanker or on the offloading facility, that hold liquefied gas to vaporize it. The blowers are also used to heat cold gas (gas considerably below 0° C.) in a containment structure on the offloading facility that holds cold gaseous hydrocarbons, so the gaseous hydrocarbons can be readily passed to a storage or distribution facility on shore or a storage cavern.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a partial isometric view of a LNG tanker and an offloading facility of the present invention, lying near shore, but with pipes and corresponding fans on the offloading facility not shown.

FIG. 2 is a partial side elevation view of the tanker and offloading facility of FIG. 1.

FIG. 3 is a diagram of the heating process performed by the system of FIG. 1.

FIG. 4 is an isometric view of the offloading facility of FIG. 1, but with the tanker-directed fans not included and with pipes on the offloading facility and corresponding fans included.

### DESCRIPTION OF THE PREFERRED EMBODIMENTS

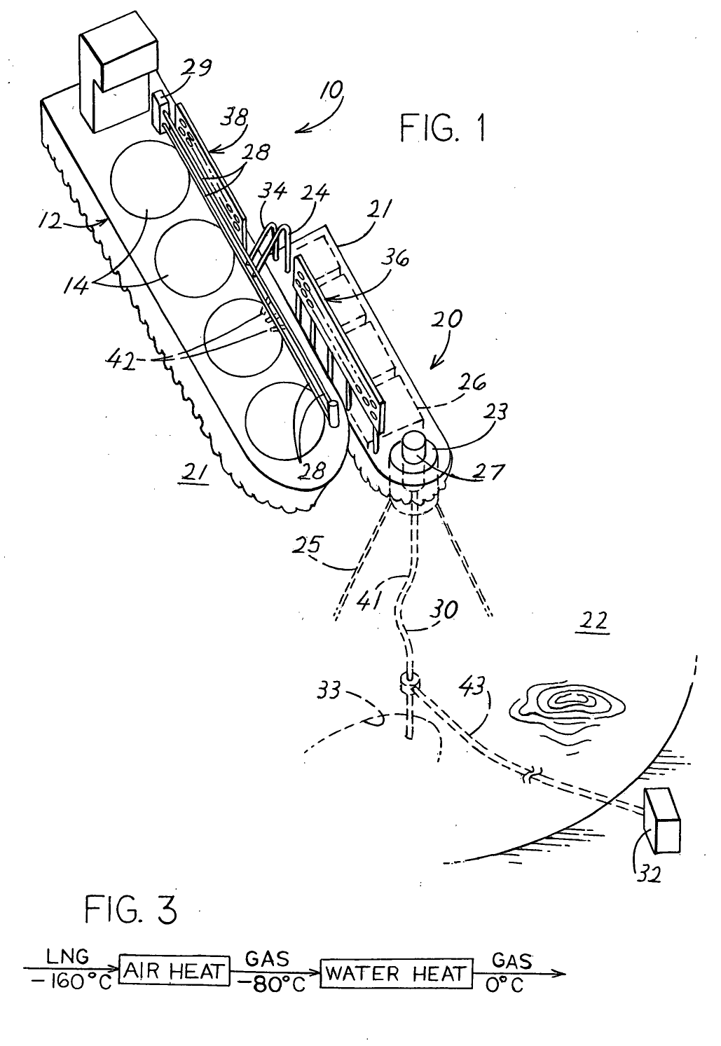

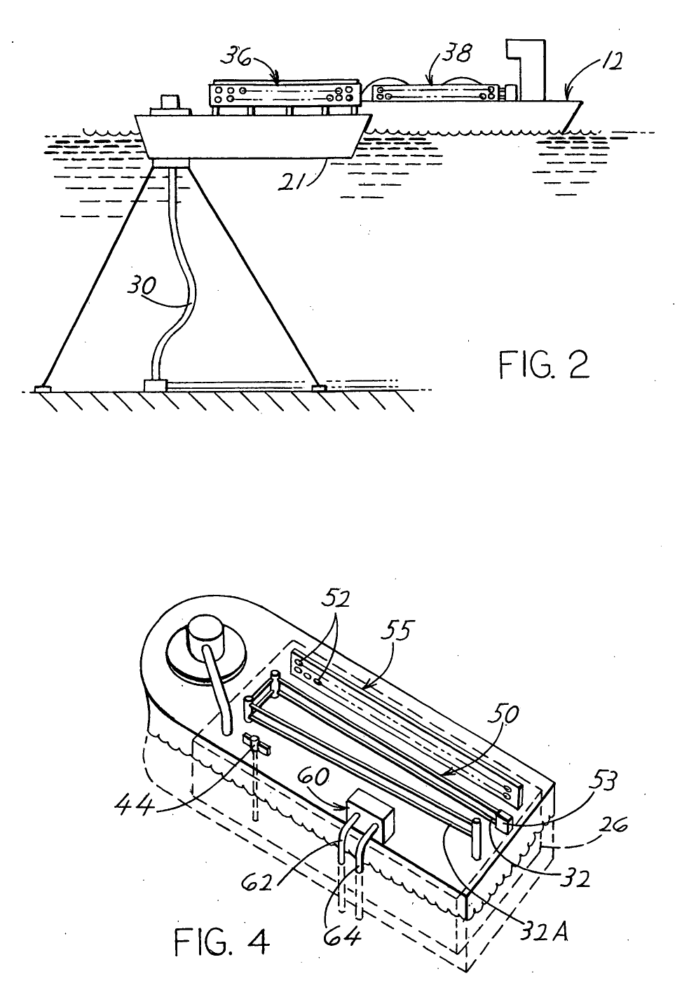

FIG. 1 illustrates a system 10 which includes a tanker 12 that has tanks 14 that carry liquefied gas, that is, hydrocarbons that are gaseous at environmental temperatures (e.g. 15° C.) and pressures (e.g. one bar) and that have been cooled to liquify them. The system also includes an offloading facility 20 that receives the liquefied gas from the tanker. The tanker typically carries a large quantity of thousands of tons of liquefied gas, a long distance that is hundreds or thousands of kilometers, with LNG maintained at a temperature such as −160° C. to keep it liquid at atmospheric pressure. The tanker is moored to the offloading facility 20 at a location 21 which can be far from shore or near shore, with a harbor 22 shown. The tanker transfers liquefied gas through a loading arm 24 that may include a cryogenic hose to a one or more tanks 26 on the offloading facility. The cold liquid hydrocarbon gas must be heated to a gaseous state, or regassed, and the cold gaseous hydrocarbon must be heated to a temperature of at least about 0° C. to constitute warmed gas, before the gas is transferred though an underwater conduit 30 to a warmed gas storage facility. A “gas storage facility” or “storage facility” is a facility that stores and/or distributes hydrocarbon gas. Such a gas storage facility can be an onshore facility 32 that distributes or uses the gas, and/or an underground cavern 33 that stores the warmed gas and later delivers it to the onshore facility. If the cold gaseous hydrocarbon temperature is much under 0° C. (under −5° C. and especially if below −10° C.) then damaging ice will form about the underwater conduit. A long cryogenic underwater hose is too costly to use.

The particular offloading facility 20 includes a floating structure such as a barge 21 that can support a turret 23 that is anchored to the sea floor by catenary lines 25. A fluid swivel 27 on the turret connects to the underwater conduit 30 which includes a hose 41 and sea floor pipeline 43. The tanker is moored to the barge so they weathervane together (change their headings with changing winds, waves and currents). Another type of offloading facility is a fixed platform, although that is much more expensive. A floating structure can be spread moored. Any type of offloading facility usually lies more than 0.2 kilometer from shore, and usually more than 2 kilometers from shore to minimize danger to persons and structures on shore in the event of a fire or explosion.

As discussed earlier, previous offloading systems have used sea water to heat the cold (liquid or gaseous and under −10° C.) hydrocarbon gas, but the resulting large quantities of very cold water can harm sea life. Localities are passing increasingly severe law that limit how much water in their area can be cooled and the water discharge temperature. Heating by burning some of the gas offloaded by the tanker uses up valuable gas and creates pollution.

In accordance with the present invention, applicant heats the liquefied gas to turn it into its gaseous phase, and heats the resulting cold (under −10° C.) hydrocarbon gas, at least partially by blowing air against containment structures that contain the hydrocarbon gas (in a liquid or cold-gaseous state). Any heat exchanger that is thermally coupled to the containment structures is considered part of the containment structure. In FIG. 1, the containment structures include the tanker tanks 14 on the tanker, the tank(s) 26 on the offloading barge, pipes 28 on the tanker, and pipes 32 (FIG. 4) on the offloading facility that carry liquefied gas or cold hydrocarbon gas. FIG. 1 shows a bank of fans 36 on the barge and a bank of fans 38 on the tanker, that form blowers that blow air across the tanks 14 and pipes 28 on the tanker. A pump 29 pumps cold gas (primarily liquefied gas) through the pipes 28.

The tanker 12 has a refrigeration system that keeps the liquefied gas cold during a transport time of perhaps 10 days, and which is turned off when offloading to the facility 20 is proceeding. It may take a few days for the liquefied gas to be offloaded through the cryogenic loading arm 24. It is important to offload the tanker quickly, because tanker rental rates are high, such as $100,000 per day. However, during the unloading time, applicant has the option to apply heat to the liquefied gas still in the tanker, and may draw off gaseous hydrocarbons through a separate hose 34 or through the loading arm. This can be accomplished by directing the banks of fans 36, 38 on the offloading facility 20 and/or on the tanker, toward tanks 14 and pipes 28 on the tanker. Heat transfer to liquefied gas in the tanker tanks can be enhanced by including heat transfer structures or heat exchangers 42 on the tanks. One example of a heat exchanger is a thermal conductor such as a copper bar that has one end in liquefied gas in the tank and an opposite end outside the tank and carrying fins. Liquefied gas in the tanks is pumped through the pipes 28 while air from the onboard fans 38 and from fans 36 on the barge blow air across the pipes.

Most of the heat transferred to the liquefied gas and to the cold gas occurs on the offloading facility and particularly on the barge or other floating structure. This can be accomplished by directing air across heat transfer structures 44 (FIG. 4) that extend into the tank(s) 26 on the offloading facility. In order for blown air to have a significant effect in heating liquefied hydrocarbons that were transported in a tanker (that carries thousands of tons of liquefied gas) and in warming the gaseous hydrocarbons, the blower or bank of fans 36, 38 and 52 should blow a plurality of millions of standard (atmospheric pressure and temperature) cubic feet (over 25 thousand cubic meters of air) per day. FIG. 4 shows that the offloading facility has a bank 50 of elongated pipes 32 that carry LNG and cold gas, pumped through the pipes by a pump 53. The liquefied gas and cold gas are heated by the blowing of ambient air across the pipes by a blower 55 formed by a bank of fans 52. Some of the pipes 32A extend at an incline in quiescent seas (no wind or waves) so the position of LNG in such pipes is predictable despite waves that tilt the barge. Other means for heating the LNG and cold gas can be used including the use of flowing sea water and even hot gas produced by burning some of the hydrocarbon gas delivered by the tanker. However, the amount of heating required by such other means is greatly reduced by the fact that much of the heating is done by blown air. The transfer of heat to pipes can be increased by spraying droplets of antifreeze on the pipes or attaching fins, to increase the effective surface area. The fans are preferably electrically energized by electricity generated by a turbine-generator unit on the offloading facility, that uses gas as a fuel.

If the tanker will return with another load of liquefied gas in 10 days, then it is important that most of the hydrocarbon gas be heated and flowed away from the barge before the tanker arrives again. FIG. 4 shows a heat exchanger 60 that is connected to hoses 62, 64 that take in and release sea water, and that is thermally coupled to liquefied gas in the tanks 26 and to cold gas that is to be warmed.

There are many advantages in using blown air to heat the liquefied and cold gas. Large fans are widely used on shore, and are of low cost to buy and maintain. Although the environmental air is cooled considerably by heating cold hydrocarbon gas, the cold environmental air is dissipated by winds. Winds are stronger offshore than on shore. Any additional heating of liquefied and cold gas by sea water involves less cooling of the surrounding sea. FIG. 3 shows one system wherein LNG at −160 degrees centigrade is vaporized and heated to −80° C. by blown air. Further heating of the cold gaseous hydrocarbons is accomplished using an intermediate fluid which can be sea water, or which can be a coolant contained in a closed loop and in contact with sea water. The gas is heated to about 0° C. and is then pumped though the undersea conduit 30 to shore.

Thus, the invention provides a means for heating liquefied hydrocarbon gas and cold (below 0° C. and usually below −10° C.) gaseous hydrocarbon which minimizes the amount of any gas burned, and minimizes the cooling of local sea water. The invention includes the blowing of environmental air across a containment structure that contains the liquefied or cold hydrocarbon gas. Fans or other blowers that blow the air can be located on an offloading facility (e.g. on the floating structure) that offloads liquefied gas from a tanker. The fans can be directed from the offloading facility against containment structures on the tanker (the tanker tanks, pipes, and heat transfer structures thermally coupled to the tanks or pipes). Fans on the offloading facility direct air against containment structures on the offloading facility. It is further possible to provide the tanker itself with a disconnectable mooring system and with a heating system of the type described.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. Apparatus for heating cold hydrocarbon gas that has been transported in a tanker as cold liquefied gas and that passes from and through containment structures as the gas is transferred from the tanker through an offloading facility to a storage facility, comprising:
at least one energized blower with a through-put of air of a plurality of millions of standard cubic feet a day, which directs blown air in the environment at at least one of said containment structures to heat the hydrocarbon gas in the containment structures while the air becomes colder.

2. The apparatus described in claim 1 wherein:
said containment structures includes a plurality of containment structures located on said tanker and said blower blows air at at least one of said containment structures on said tanker.

3. The apparatus described in claim 2 wherein:
said containment structure includes an elongated pipe on said tanker and a pump that pump said cold liquefied gas through said pipe, said blower being positioned to blow environmental air across said pipe.

4. The apparatus described in claim 1 wherein:
said containment structures includes a plurality of containment structures located on said tanker;
said blower is located on said offloading facility, and said blower is positioned to direct air at at least one containment structure that is located on said tanker.

5. The apparatus described in claim 1 wherein:
said offloading facility includes a floating barge that carries at least one of said containment structures, and said blower is mounted on said barge and is positioned to direct blown air at said containment structure on said barge.

6. The apparatus described in claim 1 wherein:
said containment structures includes an elongated pipe through which said cold hydrocarbon gas flows, and said blower is directed at said pipe.

7. The apparatus described in claim 6 wherein:
cold hydrocarbon gas in said pipe is in a liquid form, and said pipe is inclined a plurality of degrees from the horizontal in quiescent seas, whereby to control the position of liquid hydrocarbon in large sea waves.

8. The apparatus described in claim 1 wherein:
said tanker and said offloading facility are each at least 0.2 meter from shore, to thereby dissipate said cold air and avoid harmful effects to persons on shore.

9. A method for heating cold hydrocarbon gas that has been transported in a tanker as cold liquefied gas and that passes from and through containment structures as the gas is offloaded from the tanker to an offloading facility and flowed from said offloading facility to a storage facility, comprising:
blowing air using at least one energized blower having a through-put of air of a plurality of millions of standard cubic feet a day, at said containment structures to heat the hydrocarbon gas in the containment structures while the blown air becomes colder.

10. The method described in claim 9 wherein:
said containment structures includes an elongated pipe; and including
pumping said cold liquefied gas through said pipe and directing said blower at said pipe.

11. The method described in claim 9 wherein:
at least one of said containment structures is located on said tanker, and said step of blowing includes blowing air from a blower on said offloading facility against said containment structure on said tanker.

12. The method described in claim 9 wherein:
at least one of said containment structures is located on said offloading facility, and said step of blowing includes blowing air from a blower on said offloading facility against said containment structure on said offloading facility.

13. The method described in claim 12 wherein:
said offloading facility is at least 0.2 kilometer from shore, to thereby enable dissipation of said cold blown air.

14. The method described in claim 9 including:
applying droplets of a fluid onto said containment structure, to thereby increase heat transfer between the containment structure and blown air.
